(19) United States
(12) Patent Application Publication
(10) Pub. No.: US 2020/0116522 A1
(43) Pub. Date: Apr. 16, 2020

(54) ANOMALY DETECTION APPARATUS AND ANOMALY DETECTION METHOD

(71) Applicant: KABUSHIKI KAISHA TOSHIBA, Minato-ku (JP)

(72) Inventor: Topon PAUL, Kawasaki (JP)

(73) Assignee: KABUSHIKI KAISHA TOSHIBA, Minato-ku (JP)

(21) Appl. No.: 16/564,564

(22) Filed: Sep. 9, 2019

(30) Foreign Application Priority Data
Oct. 15, 2018 (JP) 2018-194534

(51) Int. Cl. G01D 1/18; G01D 3/08; G06K 9/62

(52) U.S. Cl. CPC G01D 1/18; G06K 9/6227; G01D 3/08

(57) ABSTRACT

An anomaly detection apparatus has a model creator, based on a plurality of sensor data input sequentially in time, to create a plurality of candidate models with a plurality of techniques for detection of an anomaly of the sensor data, an accuracy calculator to calculate decision accuracies of the plurality of candidate models, a model selector to select one or more candidate models from among the plurality of candidate models based on the decision accuracies of the plurality of candidate models, to create an anomaly detection model, a data classifier to determine whether new sensor data is normal or abnormal based on the anomaly detection model, and a model updater to update the plurality of candidate models based on the decision accuracies of the plurality of candidate models calculated by the accuracy calculator and on the new sensor data determined to be normal or abnormal by the data classifier.

### CROSS REFERENCE TO RELATED APPLICATIONS

This application is based upon and claims the benefit of priority from the prior Japanese Patent Application No. 2018-194534, filed on Oct. 15, 2018, the entire contents of which are incorporated herein by reference.

### FIELD

Embodiments of the present disclosure relate to an anomaly detection apparatus and an anomaly detection method.

### BACKGROUND

In manufacturing factories, plants, etc., product quality or manufacturing processes are often monitored by various kinds of sensors installed in various apparatuses. These sensors generate a large amount of time-series waveform data or tabular data composed of a large amount of normal data and a small amount of abnormal data. Anomaly detection from a large amount of data is very important for supporting improvement in product yield, improvement in product quality, improvement in reliability of operation in manufacturing factories, plants, etc., and appropriate maintenance planning. Under such a background, an anomaly detection apparatus has been proposed, which creates an anomaly detection model based on sensor data in manufacturing factories and plants, and based on the created anomaly detection model, determines whether newly acquired sensor data are normal or abnormal.

However, there are various techniques for creating anomaly detection models and different models are created per technique, so that it is difficult to select an optimum model. Moreover, since abnormal data have a tendency to increase with passage of time, it is not always desirable to continuously use an anomaly detection model created in an initial state with a higher ratio of normal data.

### BRIEF DESCRIPTION OF THE DRAWINGS

FIG. 1 is a block diagram of an anomaly detection apparatus according to a first embodiment;

FIG. 2 is a figure showing a specific example in which the anomaly detection apparatus according to the first embodiment creates an anomaly detection model;

FIG. 3 is a flowchart showing an operation of the anomaly detection apparatus according to the first embodiment;

FIG. 4 is a block diagram schematically showing the configuration of an anomaly detection apparatus according to a second embodiment;

FIG. 5 is a figure showing a specific example in which the anomaly detection apparatus according to the second embodiment creates an anomaly detection model;

FIG. 6 is a flowchart showing an operation of the anomaly detection apparatus according to the second embodiment;

FIG. 7 is a figure showing an example of a GUI window via which a user performs various selections and visualization;

FIG. 8 is a block diagram schematically showing the configuration of an anomaly detection apparatus according to a third embodiment;

FIG. 9 is a figure showing an example in which normal data is classified into three distinctive data groups;

FIG. 10 is a flowchart showing operations of a group maker and a technique selector according to the third embodiment;

FIG. 11 is a figure schematically illustrating the significance of grouping to be performed by the anomaly detection apparatus according to the third embodiment;

FIG. 12 is a figure showing an example of grouping normal data using a genetic algorithm;

FIG. 13 is a figure explaining the process of the genetic algorithm to be used in assigning a technique to each data group in FIG. 12;

FIG. 14A is a figure showing a technique list;

FIG. 14B is a figure showing a sensor data list;

FIG. 14C is a figure showing initial candidate model groups;

FIG. 15A is a figure showing a list of the most previous candidate solutions for a plurality of candidate model groups;

FIG. 15B is a figure showing a list of candidate solutions obtained by applying crossover and mutation; and

FIG. 16 is a figure showing an example of a GUI window for data group evaluation.

### DETAILED DESCRIPTION

According to one embodiment, an anomaly detection apparatus has:

a model creator, based on a plurality of sensor data input sequentially in time, to create a plurality of candidate models with a plurality of techniques for detection of an anomaly of the sensor data;

an accuracy calculator to calculate decision accuracies of the plurality of candidate models;

a model selector to select one or more candidate models from among the plurality of candidate models based on the decision accuracies of the plurality of candidate models, to create an anomaly detection model;

a data classifier to determine whether new sensor data is normal or abnormal based on the anomaly detection model; and

a model updater to update the plurality of candidate models based on the decision accuracies of the plurality of candidate models calculated by the accuracy calculator and on the new sensor data determined to be normal or abnormal by the data classifier.

Hereinafter, embodiments of the present disclosure will now be explained with reference to the accompanying drawings. In the following embodiments, a unique configuration and operation of an anomaly detection apparatus will be mainly explained. However, the anomaly detection apparatus may have other configurations and operations omitted in the following explanation.

### First Embodiment

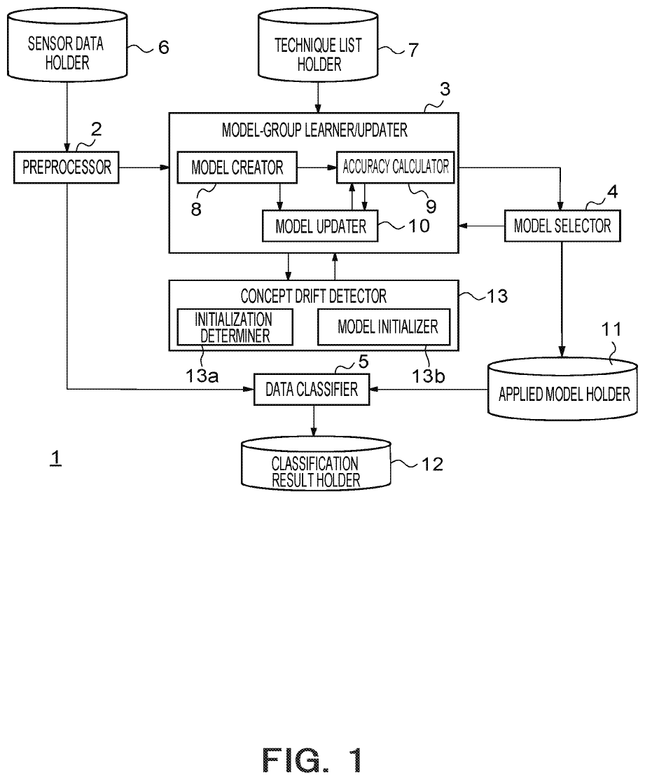

FIG. 1 is a block diagram of an anomaly detection apparatus 1 according to a first embodiment. The anomaly detection apparatus 1 of FIG. 1 is provided with a preprocessor 2, a model-group learner/updater 3, a model selector 4, and a data classifier 5. In addition, the anomaly detection apparatus 1 of FIG. 1 may be provided with a sensor data holder 6 that stores sensor data detected by various sensors installed in manufacturing factories, plants, etc. However, the sensor data holder 6 is not an essential component. Sensor data from various sensors may be input in real time to the anomaly detection apparatus 1 of FIG. 1.

The sensor data may include time-series waveform data incrementally created by each sensor or tabular data of statistical values into which the time-series waveform data are converted. The sensor data include training data to be utilized in learning an anomaly detection model and test data to be utilized in detecting unknown anomalies. The training data include at least either of normal data and abnormal data of each sensor. Not only at least either of normal data and abnormal data of one kind of sensor, the training data may include at least either of normal data and abnormal data of plural kinds of sensors. Each sensor data may carry a flag for distinguishing between training data and test data. Moreover, each sensor data may carry a flag that indicates whether preprocessing is required for the sensor data.

Although the preprocessor 2 of FIG. 1 is not an essential component, an example in which the anomaly detection apparatus 1 of FIG. 1 is provided with the preprocessor 2 will be explained hereinbelow. The preprocessor 2 performs preprocessing of sensor data. When the sensor data is time-series waveform data, it is sometimes required to adjust the length of the time-series waveform data, as preprocessing. In this case, the preprocessor 2 makes the lengths of time-series waveform data equal to one another in time. Or, the preprocessor 2 may smooth the time-series waveform data. For smoothing, a low-pass filter, a high-pass filter, kernel density estimation, etc., may be applied. When the anomaly detection model cannot process the time-series waveform data, the preprocessor 2 may perform a process of extracting features from the time-series waveform data. The features to be extracted from the time-series waveform data are statistical values. In more specifically, the statistical values include a maximum value, a median value, a minimum value, an average value, a standard deviation value, kurtosis, skewness, autocorrelation, etc. Or, the features to be extracted by the preprocessor 2 may be waveform amplitude, state level, undershoot and overshoot, reference plane, transition time, etc., of the time-series waveform data. Or, the preprocessor 2 may divide the time-series waveform data into a plurality of segments and extract features prior to each segment. Data created by extracting the features from the time-series waveform data become tabular data. Data created by the preprocessor 2 may be stored in the sensor data holder 6 of FIG. 1.

Candidate models to become candidates for the anomaly detection model can be created by a plurality of techniques. For example, the anomaly detection apparatus 1 of FIG. 1 may be provided with a technique list holder 7 to hold a technique list in which a plurality of techniques are listed. The technique list includes techniques for unsupervised learning and techniques for supervised learning. The techniques for unsupervised learning may, for example, include a technique using the conventional one-class support vector machine, a clustering technique (k-means clustering, hierarchical clustering), principal component analysis, self-organizing maps, deep learning, unsupervised incremental learning, etc. The techniques for supervised learning may, for example, include a technique using a classifier, a technique using the incremental support vector machine, an incremental decision tree, an incremental deep convolutional neural network, Learn++, Fuzzy ARTMAP, and so on. The technique list holder 7 may be united with the model-group learner/updater 3.

The model-group learner/updater 3 selects a plurality of techniques for unsupervised learning and supervised learning from the technique list, learns a candidate model group using initial training data, and updates the candidate model group using incrementally arriving training data.

The model-group learner/updater 3 has a model creator 8, an accuracy calculator 9, and a model updater 10. Based on a plurality of sensor data input sequentially in time, the model creator 8 creates a plurality of candidate models for detecting anomaly of sensor data, with a plurality of techniques. The accuracy calculator 9 calculates decision accuracies of the plurality of candidate models. The model updater 10 updates the plurality of candidate models based on the decision accuracies calculated by the accuracy calculator 9 and new sensor data which has been determined to be normal or abnormal. The model updater 10 may update the plurality of candidate models based on at least either of new sensor data which has been determined to be normal or abnormal by the knowledge of an expert and new sensor data which has been determined to be normal or abnormal based on an anomaly detection model in addition to the knowledge of the expert.

The model updater 10 can perform model updating with any one of a plurality of systems. The following first to fourth systems are typical systems.

In the first system, the model updater 10 collects all incrementally-arriving training data and newly learns each candidate model using all techniques selected by the model creator 8, at a timing at which the training data incrementally arrive. In the first system, a storage device to store a large amount of training data is required.

In the second system, the model updater 10 discards past training data and newly learns each candidate model using all techniques selected by the model creator 8 using incrementally-arriving training data only. In the second system, the decision accuracies of learning models may vary.

In the third system, the model updater 10 learns candidate models created by all techniques selected by the model creator 8 using initial training data, updates parameters of a candidate model group using incrementally-arriving training data, and discards all training data after updating the candidate models. In the third system, a storage device to store a large amount of training data is not required.

In the fourth system, like the third system, the model updater 10 learns candidate models created by all techniques selected by the model creator 8 using initial training data and updates parameters of a candidate model group using incrementally-arriving training data, however, holds part of training data after model updating. In this case, a technique to select training data to be held is required. Since the ratio of abnormal data included in training data is generally low, all abnormal data, incrementally-arriving training data, and normal data randomly picked up from past normal data can be held.

The system to be selected by the model updater 10 may change depending on the technique selected by the model creator 8. A user may determine in advance the system to be selected by the model updater 10.

Based on the decision accuracies of a plurality of candidate models, the model selector 4 selects one or more candidate models from among the plurality of candidate models to create an anomaly detection model. Specifically, the model selector 4 selects one or more excellent candidate models from a candidate model group learned or updated by the model-group learner/updater 3. When the model selector 4 selects a plurality of candidate models, the model selector 4 uses the selected plurality of candidate models to create a metamodel, and then holds an anomaly detection model (referred to as an applied model, hereinafter) to which the metamodel is applied, in an applied model holder 11. When the model-group learner/updater 3 learns n candidate models, the number of combinations of the candidate models is 2ⁿ−1. Therefore, the model selector 4 can select an excellent candidate model group using a combinatorial optimization technique, a heuristic technique or a greedy strategy. As the combinatorial optimization technique for the candidate model group, a genetic algorithm or genetic programming can be used. Since a comprehensive determination is performed with a metamodel created using a plurality of candidate models, a rule for the metamodel is required. The metamodel can be created utilizing majority voting, an OR rule or a rule using genetic programming. In the majority voting, if the decision result of a lot of candidate models is abnormal, test data is determined to be abnormal. In the OR rule, if the decision result of one or more candidate models is abnormal, test data is determined to be abnormal. In the genetic programming, the following rule can, for example, be made.

IF(decision on candidate model 1=abnormal AND decision on candidate model 2=normal)OR(decision on candidate model 1=normal AND decision on candidate model 2=abnormal) THEN (test data=abnormal)

The applied model holder 11 holds the metamodel created based on the candidate model group selected by the model selector 4, as the applied model.

The data classifier 5 determines whether new sensor data is normal or abnormal. In more specifically, the data classifier 5 uses the metamodel created using the candidate model group to classify whether new sensor data (test data) preprocessed by the preprocessor 2 is normal or abnormal and holds its classification result in a classification result holder 12.

The anomaly detection apparatus 1 of FIG. 1 may be provided with a concept drift detector (initializer) 13. The concept drift detector 13 may have an initialization determiner 13a and a model initializer 13b. The initialization determiner 13a determines whether numerical values indicating the decision accuracies of the plurality of candidate models have all become equal to or smaller than a predetermined value. The model initializer 13b initializes the anomaly detection model when the numerical values indicating the decision accuracies of the plurality of candidate models are all determined to be equal to or smaller than the predetermined value.

In more specifically, the concept drift detector 13 detects whether incrementally-arriving training data has largely changed from prior training data when the model-group learner/updater 3 updates a model group using the incrementally-arriving training data. When the concept drift detector 13 detects a concept drift, the concept drift detector 13 issues an instruction to the model-group learner/updater 3 to reset model learning and an instruction to the sensor data holder 6 to discard past training data. For a concept-drift detecting technique, an evaluation of whether the decision accuracies of a plurality of or all candidate models have been lowered after the model-group learner/updater 3 updated the candidate model group, can be utilized. The concept drift detector 13 may be united with the model-group learner/updater 3.

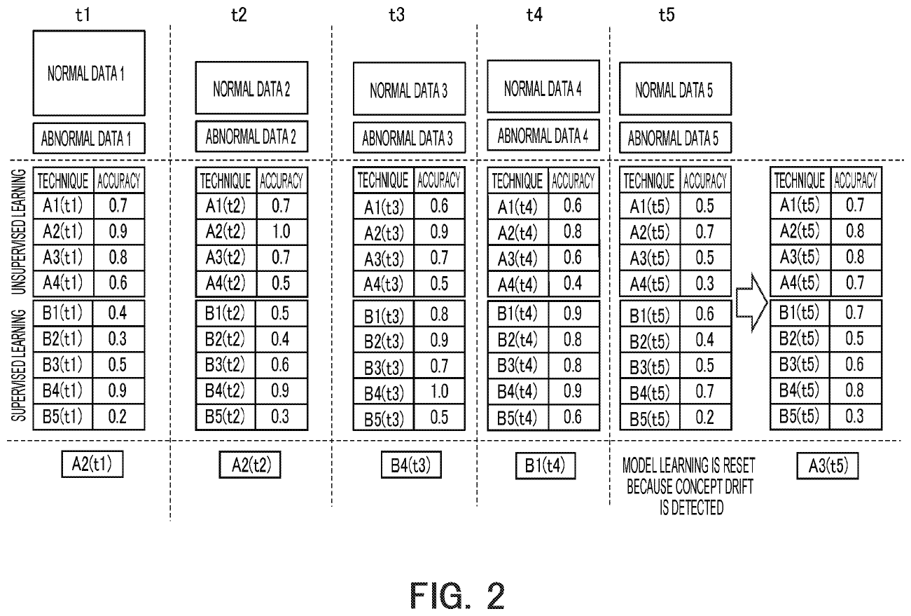

FIG. 2 is a figure showing a specific example in which the anomaly detection apparatus 1 according to the first embodiment creates an anomaly detection model. In the example of FIG. 2, the sensor data holder 6 supplies, at time t1, initial training data composed of normal data 1 and abnormal data 1, and supplies, at time t2, training data 2 composed of normal data 2 and abnormal data 2, and supplies, at time t3, training data 3 composed of normal data 3 and abnormal data 3, and supplies, at time t4, training data 4 composed of normal data 4 and abnormal data 4, and incrementally supplies, at time t5, training data 5 composed of normal data 5 and abnormal data 5, to the preprocessor 2.

The technique list holder 7 holds a technique list that includes {A1, A2, A3, A4} as techniques for unsupervised learning and {B1, B2, B3, B4, B5} as techniques for supervised learning.

The model-group learner/updater 3 uses the initial training data to learn models created by all techniques, to calculate decision accuracies. The initial training data has such a feature that the ratio of the normal data 1 is higher than the ratio of the abnormal data 1. The model creator 8 in the model-group learner/updater 3 performs unsupervised learning and supervised learning. In the unsupervised learning, the model creator 8 uses training data composed of normal data only to create a plurality of candidate models {A1(t1), A2(t1), A3(t1), A4(t1)} with a plurality of techniques {A1, A2, A3, A4}. The accuracy calculator 9 calculates decision accuracies of these candidate models, which are {0.7, 0.9, 0.8, 0.6} in this example. In the supervised learning, the model creator 8 uses training data composed of normal data and abnormal data to create a plurality of candidate models {B1(t1), B2(t1), B3(t1), B4(t1), B5(t1)} with a plurality of techniques {B1, B2, B3, B4, B5}. The decision accuracies of these candidate models are {0.4, 0.3, 0.5, 0.9. 0.2}.

The model selector 4 selects the best model A2(t1), as the anomaly detection model, from among the models {A1(t1), A2(t1), A3(t1), A4(t1)} created using the unsupervised learning techniques, because of a higher average decision accuracy of these models.

Sensor data, which are supplied from the sensor data holder 6 during the period from time t1 to time t2 that is the next model updating timing, are determined to be normal or abnormal using the anomaly detection model A2(t1) selected by the model selector 4 at time t1. The determination result is held by the classification result holder 12. The determination result of normal or abnormal during time t1 to time t2 may be utilized for updating the candidate models at time t2.

Subsequently, the process at time t2 will be explained. At time t2, the sensor data holder 6 supplies the training data 2 composed of the normal data 2 and the abnormal data 2, to the preprocessor 2. The preprocessor 2 performs preprocessing of the training data 2. The model-group learner/updater 3 uses the preprocessed training data 2 to update the candidate models created by all techniques and calculates decision accuracies.

In the unsupervised learning, the model creator 8 uses training data composed of normal data only to create a plurality of candidate models {A1(t2), A2(t2), A3(t2), A4(t2)} with the plurality of techniques {A1, A2, A3, A4}. The accuracy calculator 9 calculates decision accuracies of these candidate models, which are {0.7, 1.0, 0.7, 0.5} in this example. In the supervised learning, the model creator 8 uses training data composed of normal data and abnormal data to create a plurality of candidate models {B1(t2), B2(t2), B3(t2), B4(t2), B5(t2)} with the plurality of techniques {B1, B2, B3, B4, B5}. The decision accuracies of these candidate models are {0.5, 0.4, 0.6, 0.9. 0.3}.

The model selector 4 selects the best model A2(t2), as the anomaly detection model, from among the models {A1(t2), A2(t2), A3(t2), A4(t2)} created by the unsupervised learning techniques, because of a higher average decision accuracy of these models.

Subsequently, the process at time t3 will be explained. At time t3, the sensor data holder 6 supplies the training data 3 composed of the normal data 3 and the abnormal data 3 to the preprocessor 2. The preprocessor 2 performs preprocessing of the training data 3. The model-group learner/updater 3 uses the preprocessed training data 3 to update the candidate models created by all techniques and calculates decision accuracies.

In the unsupervised learning, the model creator 8 uses training data composed of normal data only to create a plurality of candidate models {A1(t3), A2(t3), A3(t3), A4(t3)} with the plurality of techniques {A1, A2, A3, A4}. The accuracy calculator 9 calculates decision accuracies of these candidate models, which are {0.6, 0.9, 0.7, 0.5} in this example. In the supervised learning, the model creator 8 uses training data composed of normal data and abnormal data to create a plurality of candidate models {B1(t3), B2(t3), B3(t3), B4(t3), B5(t3)} with the plurality of techniques {B1, B2, B3, B4, B5}. The decision accuracies of these candidate models are {0.8, 0.9, 0.7, 1.0. 0.5}.

The model selector 4 selects the best model B4(t3), as the anomaly detection model, from among the models {B1(t3), B2(t3), B3(t3), B4(t3), B5(t3)} created by the supervised learning techniques, because of a higher average decision accuracy of these models.

The operation at time t4 is similar to the operation at time t3, and hence the explanation thereof is omitted. Lastly, the process at time t5 will be explained. At time t5, the sensor data holder 6 supplies the training data 5 composed of the normal data 5 and the abnormal data 5 to the preprocessor 2. The preprocessor 2 performs preprocessing of the training data 5. The model-group learner/updater 3 uses the preprocessed training data 5 to update the candidate models created by all techniques and calculates decision accuracies.

In the unsupervised learning, the model creator 8 uses training data composed of normal data only to create a plurality of candidate models {A1(t5), A2(t5), A3(t5), A4(t5)} by the plurality of techniques {A1, A2, A3, A4}. The accuracy calculator 9 calculates decision accuracies of these candidate models, which are {0.5, 0.7, 0.5, 0.3} in this example. In the supervised learning, the model creator 8 uses training data composed of normal data and abnormal data to create a plurality of candidate models {B1(t5), B2(t5), B3(t5), B4(t5), B5(t5)} with the plurality of techniques {B1, B2, B3, B4, B5}. The decision accuracies of these candidate models are {0.6, 0.4, 0.5, 0.7. 0.2}.

The model selector 4 selects the best model B4(t5), as the anomaly detection model, from among the models {B1(t5), B2(t5), B3(t5), B4(t5), B5(t5)} created by the supervised learning techniques, because of a higher average decision accuracy of these models.

Since, compared with the decision accuracies at time t4, the decision accuracies of all candidate models are lowered, the concept drift detector 13 determines that a concept drift has occurred, and hence issues an instruction to the model-group learner/updater 3 to reset model learning and an instruction to the sensor data holder 6 to discard past training data. The model-group learner/updater 3 receives the model-learning reset instruction from the concept drift detector 13 to learn the models created by all techniques, using the training data 5 only and calculates decision accuracies.

In the unsupervised learning, the model creator 8 uses training data composed of normal data only to create a plurality of candidate models {A1(t5), A2(t5), A3(t5), A4(t5)} with the plurality of techniques {A1, A2, A3, A4}. The accuracy calculator 9 calculates decision accuracies of these candidate models, which are {0.7, 0.8, 0.8, 0.7} in this example. In the supervised learning, the model creator 8 uses training data composed of normal data and abnormal data to create a plurality of candidate models {B1(t5), B2(t5), B3(t5), B4(t5), B5(t5)} with the plurality of techniques {B1, B2, B3, B4, B5}. The decision accuracies of these candidate models are {0.7, 0.5, 0.6, 0.8. 0.3}.

The model selector 4 selects the best model A3(t5), as the anomaly detection model, from among the models {A1(t5), A2(t5), A3(t5), A4(t5)} created by the unsupervised learning techniques, because of a higher average decision accuracy of these models.

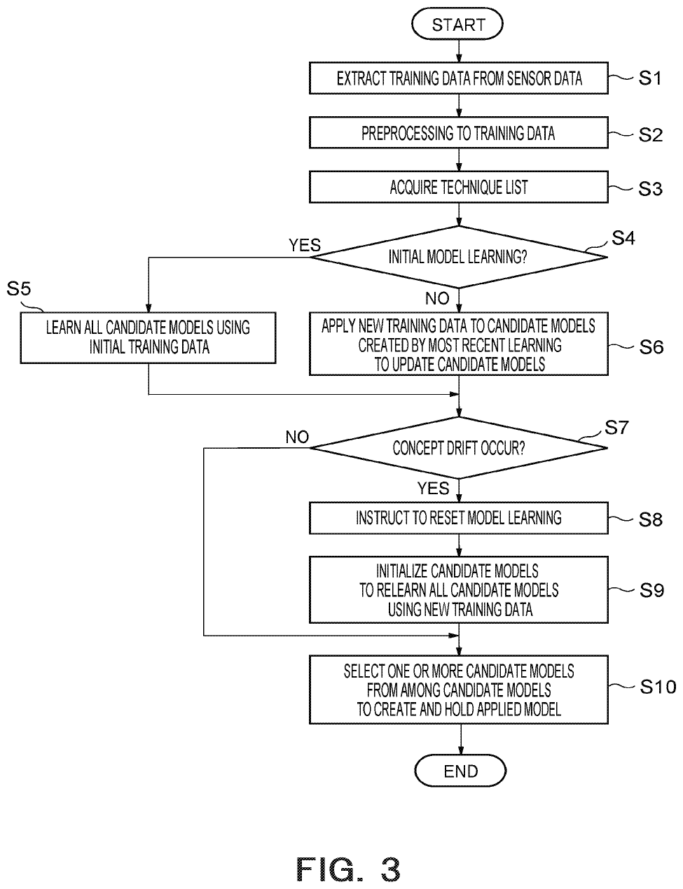

FIG. 3 is a flowchart showing an operation of the anomaly detection apparatus 1 according to the first embodiment. First of all, the preprocessor 2 extracts training data from the sensor data supplied from the sensor data holder 6 (step S1). Subsequently, the preprocessor 2 performs preprocessing to the training data (step S2). As the preprocessing, for example, the length of the training data is adjusted.

The model-group learner/updater 3 acquires a technique list from the technique list holder 7 (step S3). Subsequently, the model-group learner/updater 3 determines whether to perform initial model learning (step S4).

In the case of initial model learning (YES in step S4), the model-group learner/updater 3 uses initial training data to learn all candidate models (step S5). If determined in step S4 not to perform the initial model learning (NO in step S4), the model-group learner/updater 3 applies new training data to candidate models created by the most recent learning to update the candidate models (step S6).

When step S5 or S6 finishes, the concept drift detector 13 detects whether a concept drift has occurred (step S7). If the concept drift has occurred (YES in step S7), the concept drift detector 13 issues an instruction to reset model learning to the model-group learner/updater 3 (step S8). At this time, the model-group learner/updater 3 initializes the candidate models and relearns all candidate models using new training data (step S9).

Subsequently, based on the decision accuracies of a plurality of candidate models, the model selector 4 selects one or more candidate models from among the plurality of candidate models to create an applied model and holds the applied model in the applied model holder 11 (step S10).

As described above, the concept drift detector 13 may be omitted. In the case of omitting the concept drift detector 13, steps S7 to S9 of FIG. 3 are not necessary.

As described above, in the first embodiment, unsupervised learning is performed using a plurality of techniques to create a plurality of candidate models and detect the decision accuracies of the plurality of candidate models, and also supervised learning is performed using a plurality of techniques to create a plurality of candidate models and detect the decision accuracies of the plurality of candidate models. Then, the optimum candidate model is selected as the applied model from among the plurality of candidate models with higher decision accuracy. Therefore, the candidate-model decision accuracy can be highered. Moreover, since candidate model updating is continuously performed using a plurality of sensor data input sequentially in time, even if the ratio of normal data and abnormal data varies with the elapse of time, the candidate models can be updated in accordance with the change in ratio, and hence candidate model reliability can be improved. When the decision accuracies of the plurality of candidate models are lowered in a similar manner, it is determined that a concept drift has occurred and then the candidate models are reset and past sensor data are discarded, to create new candidate models again. Therefore, when the kind of sensor data changes in the course of creation of an anomaly detection model, a new anomaly detection model can be created. Moreover, the model-group learner/updater 3 and the data classifier 5 can perform their operations after preprocessing is performed to each sensor data. Therefore, even if the length in time and the feature are different per sensor data, an anomaly detection model with a high anomaly-detection decision accuracy can be created without depending on sensor data.

### Second Embodiment

A second embodiment is to select a candidate model group including one or more candidate models from among a plurality of candidate models and, from the candidate model group, select an applied model group including one or more candidate models, and then decide a metamodel (applied model) created based on the selected applied model group, as an anomaly detection model.

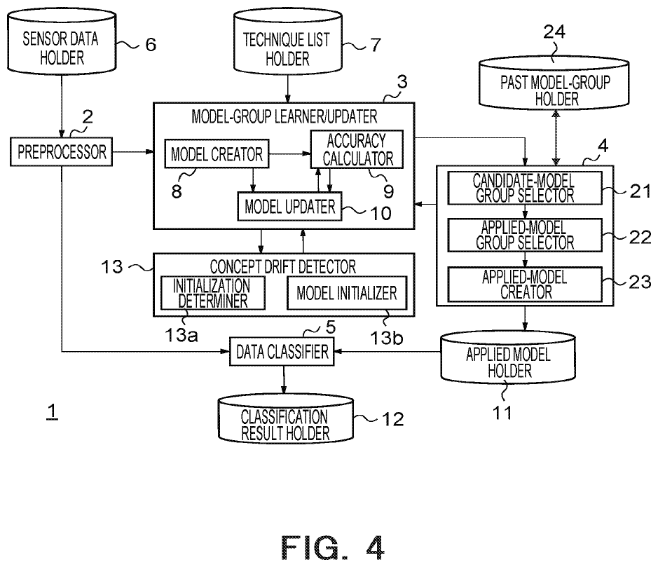

FIG. 4 is a block diagram schematically showing the configuration of an anomaly detection apparatus 1 according to the second embodiment. The anomaly detection apparatus 1 of FIG. 4 is different in process of the model selector 4 from the anomaly detection apparatus 1 of FIG. 1. The model selector 4 of FIG. 4 has a candidate-model group selector 21, an applied-model group selector 22, and an applied-model creator 23.

The candidate-model group selector 21 selects either a first candidate model group including a plurality of candidate models created based on sensor data determined to be normal by the data classifier 5 or a second candidate model group including a plurality of candidate models created based on sensor data determined to be normal or abnormal by the data classifier 5. The candidate-model group selector 21 may select either the first candidate model group or the second candidate model group based on the decision accuracies of the plurality of candidate models in the first candidate model group and the decision accuracies of the plurality of candidate models in the second candidate model group.

The first candidate model group and the second candidate model group may include, not only the current plurality of candidate models, but also a plurality of past candidate models held by a past model-group holder 24. Therefore, the candidate-model group selector 21 can select a plurality of excellent candidate models from the current candidate model group and the past candidate model group. As a selection technique, a current or a past candidate model group learned using an unsupervised learning technique and a current or a past candidate model group learned using a supervised learning technique can be selected.

Moreover, a fixed number of candidate models may be selected from a combination of a candidate model group learned using an unsupervised learning technique and a candidate model group learned using a supervised learning technique. As an evaluation criterion in selection, a model-group average decision accuracy can be utilized. When selecting one candidate model group from a candidate model group learned using an unsupervised learning technique and a candidate model group learned using a supervised learning technique, a candidate model group with a higher average decision accuracy is selected. When selecting a candidate model group including a fixed number of candidate models, from a candidate model group learned using an unsupervised learning technique and a candidate model group learned using a supervised learning technique, a fixed number of candidate models with higher decision accuracies may be selected. When incrementally-arriving training data is noisy training data and the noisy training data is used for updating some candidate models, past candidate models may be utilized in selection of candidate models because the decision accuracies of updated candidate models may be lowered. In other words, when the decision accuracy is lowered at the time of updating a candidate model group using incrementally-arriving training data, a past candidate model may be used instead of the updated candidate model.

The past model-group holder 24 holds the candidate model group selected by the candidate-model group selector 21 and the past candidate model group. A candidate model to be held may be previously decided according to which past step selected the candidate model. Or, the number of candidate models to be held may be previously decided. The candidate-model group selector 21 may be provided with the function of the past model-group holder 24.

The applied-model group selector 22 selects an applied model including one or more candidate models from the first or second candidate model group selected by the candidate-model group selector 21. The applied-model group selector 22 may select an applied model group based on the decision accuracies of a plurality of candidate models in the first or second candidate model group selected by the candidate-model group selector 21.

In more specifically, the applied-model group selector 22 selects one or more candidate model with higher accuracies from the candidate model group selected by the candidate-model group selector 21. When the candidate-model group selector 21 selects n candidate models, the number of combinations of the candidate models is 2ⁿ−1. The applied-model group selector 22 can create applied models with high accuracies using a combinatorial optimization technique, a heuristic technique or a greedy strategy. As the combinatorial optimization technique, a genetic algorithm and genetic programming can be used.

The applied-model group creator 23 creates a metamodel from the applied model group selected by the applied-model group selector 22 and holds the created metamodel in the applied model holder 11. Since a comprehensive decision is performed with a metamodel created using a plurality of candidate models, a rule for the metamodel is required. The metamodel can be created utilizing majority voting, an OR rule or a rule using genetic programming. In the majority voting, if the decision result of a lot of candidate models is abnormal, test data is determined to be abnormal. In the OR rule, if the decision result of one or more candidate models is abnormal, test data is determined to be abnormal. In the genetic programming, the following rule can, for example, be made.

IF(decision on candidate model 1=abnormal AND decision on candidate model 2=normal)OR(decision on candidate model 1=normal AND decision on candidate model 2=abnormal)

The applied model holder 11 holds the applied model group selected by the applied-model group selector 22 and the metamodel created using the applied model group.

The data classifier 5 uses the applied model group held by the applied model holder 11 and the metamodel created using the applied model group, to classify preprocessed test data and store its classification result in the classification result holder 12. In other words, the data classifier 5 determines whether the test data is abnormal or normal.

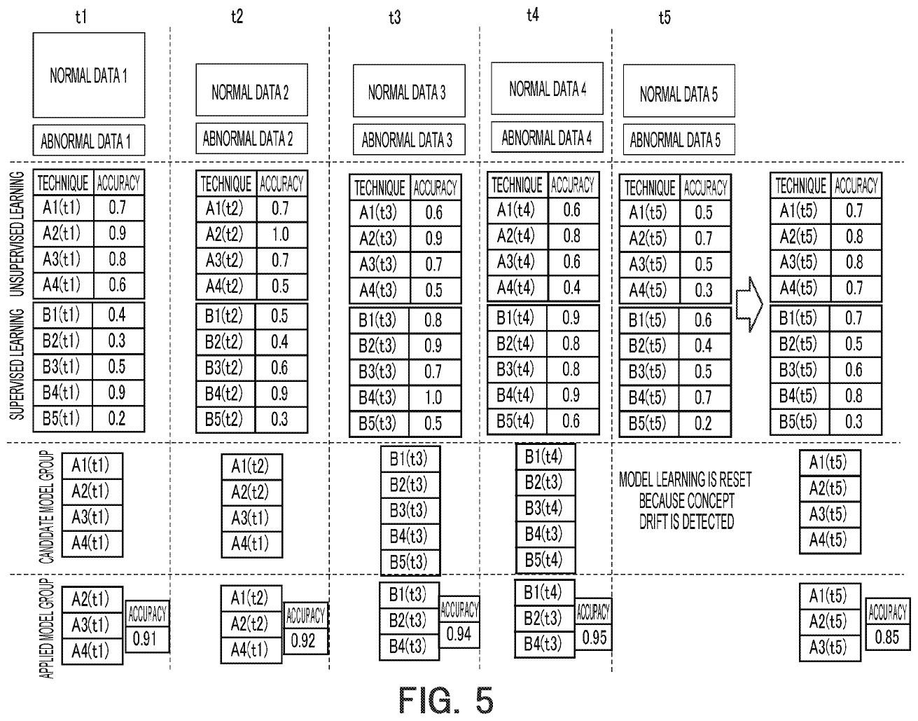

FIG. 5 is a figure showing a specific example in which the anomaly detection apparatus 1 according to the second embodiment creates an anomaly detection model. In the example of FIG. 5, the sensor data holder 6 supplies, at time t1, initial training data composed of normal data 1 and abnormal data 1, and supplies, at time t2, training data composed of normal data 2 and abnormal data 2, and supplies, at time t3, training data composed of normal data 3 and abnormal data 3, and supplies, at time t4, training data composed of normal data 4 and abnormal data 4, and incrementally supplies, at time t5, training data composed of normal data 5 and abnormal data 5, to the preprocessor 2.

The technique list holder 7 holds a technique list that includes {A1, A2, A3, A4} as techniques for unsupervised learning and {B1, B2, B3, B4, B5} as techniques for supervised learning.

At time t1, the model creator 8 in the model-group learner/updater 3 uses the initial training data to perform unsupervised learning and supervised learning with a plurality of techniques. In the unsupervised learning, the model creator 8 uses training data composed of normal data only to create a plurality of candidate models {A1(t1), A2(t1), A3(t1), A4(t1)} with a plurality of techniques {A1, A2, A3, A4}. The accuracy calculator 9 calculates decision accuracies of these candidate models, which are {0.7, 0.9, 0.8, 0.6} in this example. In the supervised learning, the model creator 8 uses training data composed of normal data and abnormal data to create a plurality of candidate models {B1(t1), B2(t1), B3(t1), B4(t1), B5(t1)} with a plurality of techniques {B1, B2, B3, B4, B5}. The decision accuracies of these candidate models are {0.4, 0.3, 0.5, 0.9. 0.2}.

The applied-model group selector 22 selects candidate model groups {A2(t1), A3(t1), A4(t1)} for creating a metamodel with a higher decision accuracy from among a plurality of candidate model groups {A1(t1), A2(t1), A3(t1), A4(t1)} obtained by unsupervised learning. After the selection of candidate model groups, the data classifier 5 classifies test data by means of the applied model (metamodel) using {A2(t1), A3(t1), A4(t1)}, for example, by majority voting.

Subsequently, the process at time t2 will be explained. At time t2, the sensor data holder 6 supplies the training data 2 composed of the normal data 2 and the abnormal data 2, to the preprocessor 2. The preprocessor 2 performs preprocessing of the training data 2.

The model-group learner/updater 3 uses the preprocessed training data 2 to update candidate models created by all techniques and calculates decision accuracies. The models updated using the training data 2 are {A1(t2), A2(t2), A3(t2), A4(t2)} and {B1(t2), B2(t2), B3(t2), B4(t2), B5(t2)} with decision accuracies of {0.7, 1.0, 0.7, 0.5} and {0.5, 0.4, 0.6, 0.9, 0.3}, respectively.

The candidate-model group selector 21 uses, for example, an average decision accuracy to select candidate model groups. The average decision accuracy of the unsupervised model group is 0.725, whereas the average decision accuracy of the supervised model group is 0.54. Therefore, the candidate-model group selector 21 selects the unsupervised model groups {A1(t2), A2(t2), A3(t2), A4(t2)}. Subsequently, the selected candidate model groups and past candidate model groups are compared to select candidate model groups of higher decision accuracies. In the selected candidate model groups, the decision accuracies of A3(t2) and A4(t2) are lower than the decision accuracies of A3(t1) and A4(t1), and hence the candidate-model group selector 21 selects A3(t1) and A4(t1) instead of A3(t2) and A4(t2), as the candidate model groups. Accordingly, the candidate-model group selector 21 selects {A1(t2), A2(t2), A3(t1), A4(t1)} and holds these candidate model groups in the past model-group holder 24.

The applied-model group selector 22 selects applied model groups {A1(t2), A2(t2), A4(t1)} for creating an applied model (metamodel) by which a high decision accuracy can be obtained, from the selected candidate model groups {A1(t2), A2(t2), A3(t1), A4(t1)}. The data classifier 5 classifies test data by means of the applied model (metamodel) using {A1(t2), A2(t2), A4(t1)}, for example, by majority voting.

Subsequently, the process at time t3 will be explained. At time t3, the sensor data holder 6 supplies the training data 3 composed of the normal data 3 and the abnormal data 3, to the preprocessor 2. The preprocessor 2 performs preprocessing of the training data 3.

The model-group learner/updater 3 uses the preprocessed training data 3 to update the models created by all techniques and calculates decision accuracies. The models updated using the training data 3 are {A1(t3), A2(t3), A3(t3), A4(t3)} and {B1(t3), B2(t3), B3(t3), B4(t3), B5(t3)} with decision accuracies of {0.6, 0.9, 0.7, 0.5} and {0.8, 0.9, 0.7, 1.0, 0.5}, respectively.

The candidate-model group selector 21 uses, for example, an average decision accuracy to select candidate model groups. The average decision accuracy of the unsupervised model groups is 0.675, whereas the average decision accuracy of the supervised model groups is 0.78. Therefore, the candidate-model group selector 21 selects the supervised model groups {B1(t3), B2(t3), B3(t3), B4(t3), B5(t3)}. Subsequently, the selected candidate model groups and past candidate model groups are compared to select candidate model groups of higher decision accuracies. The decision accuracies of the selected candidate model groups are higher than the decision accuracies of the past candidate model groups, and hence the selected candidate model groups are held in the past model-group holder 24, with no change.

The applied-model group selector 22 selects applied model groups {B1(t3), B2(t3), B4(t3)} for creating an applied model (metamodel) by which a high decision accuracy can be obtained, from the selected candidate model groups {B1(t3), B2(t3), B3(t3), B4(t3), B5(t3)}. The data classifier 5 classifies test data by means of the applied model (metamodel) using {B1(t3), B2(t3), B4(t3)}, for example, by majority voting.

The operation at time t4 is similar to the operation at time t2, and hence the explanation thereof is omitted. Lastly, the process at time t5 will be explained. At time t5, the sensor data holder 6 supplies the training data 5 composed of the normal data 5 and the abnormal data 5 to the preprocessor 2. The preprocessor 2 performs preprocessing of the training data 5.

The model-group learner/updater 3 uses the preprocessed training data 5 to update candidate models created by all techniques and calculates decision accuracies. In the unsupervised learning, the model creator 8 creates a plurality of candidate models {A1(t5), A2(t5), A3(t5), A4(t5)} and, in the supervised learning, the model creator 8 creates a plurality of candidate models {B1(t5), B2(t5), B3(t5), B4(t5), B5(t5)}. The decision accuracies of the plurality of candidate models created by the unsupervised learning and supervised learning are {0.5, 0.7, 0.5, 0.3} and {0.6, 0.4, 0.5, 0.7, 0.2}, respectively, which are lowered than the decision accuracies of the previous time. Therefore, the concept drift detector 13 detects a concept drift, and hence issues an instruction to the model-group learner/updater 3 to reset model learning and an instruction to the sensor data holder 6 to discard past training data.

The model-group learner/updater 3 receives the model-learning reset instruction from the concept drift detector 13 to learn the models created by all techniques, using the training data 5 only, and calculates decision accuracies. The models learned using the training data 5 are {A1(t5), A2(t5), A3(t5), A4(t5)} and {B1(t5), B2(t5), B3(t5), B4(t5), B5(t5)} with decision accuracies of {0.7, 0.8, 0.8, 0.7} and {0.7, 0.5, 0.6, 0.8, 0.3}, respectively.

The candidate-model group selector 21 uses, for example, an average decision accuracy to select candidate model groups. The average decision accuracy of the unsupervised model groups is 0.75, whereas the average decision accuracy of the supervised model groups is 0.58. Therefore, the candidate-model group selector 21 selects the unsupervised model groups {A1(t5), A2(t5), A3(t5), A4(t5)} and holds these unsupervised model groups in the past model-group holder 24.

The applied-model group selector 22 selects applied model groups for creating an applied model (metamodel) by which a high decision accuracy can be obtained, from the selected candidate model groups {A1(t5), A2(t5), A3(t5), A4(t5)}. In this example, in order to create the applied model (metamodel), the applied-model selector 22 selects the applied model groups {A1(t5), A2(t5), A3(t5)}. The data classifier 5 classifies test data using the applied model (metamodel) using {A1(t5), A2(t5), A3(t5)}, for example, by majority voting.

Here, model learning using the k-nearest neighbor algorithm and the management of training data will be explained. For the unsupervised learning at time t1, for example, the k-nearest neighbor algorithm is used. At time t1, the model-group learner/updater 3 uses the training data 1 to learn a model parameter k of the k-nearest neighbor algorithm. For example, it is supposed that, at time t1, the value of the model parameter k of the k-nearest neighbor algorithm is 1. After learning another candidate model at time t1, the sensor data holder 6 discards the normal data 1.

At time t2, the model-group learner/updater 3 uses the training data 2 and the abnormal data 1 to learn the model parameter k of the k-nearest neighbor algorithm. For example, it is supposed that, at time t2, the value of the model parameter k of the k-nearest neighbor algorithm is 3. After learning another candidate model at time t2, the sensor data holder 6 discards the normal data 2. At time t3, the model-group learner/updater 3 uses the training data 3 and the abnormal data 1 and 2 to learn the model parameter k of the k-nearest neighbor algorithm. For example, it is supposed that, at time t3, the value of the model parameter k of the k-nearest neighbor algorithm is 3. After learning another candidate model at time t3, the sensor data holder 6 discards the normal data 2. Since the value of the model parameter k of the k-nearest neighbor algorithm does not change at time t3, the sensor data holder 6 can also discard the abnormal data 3.

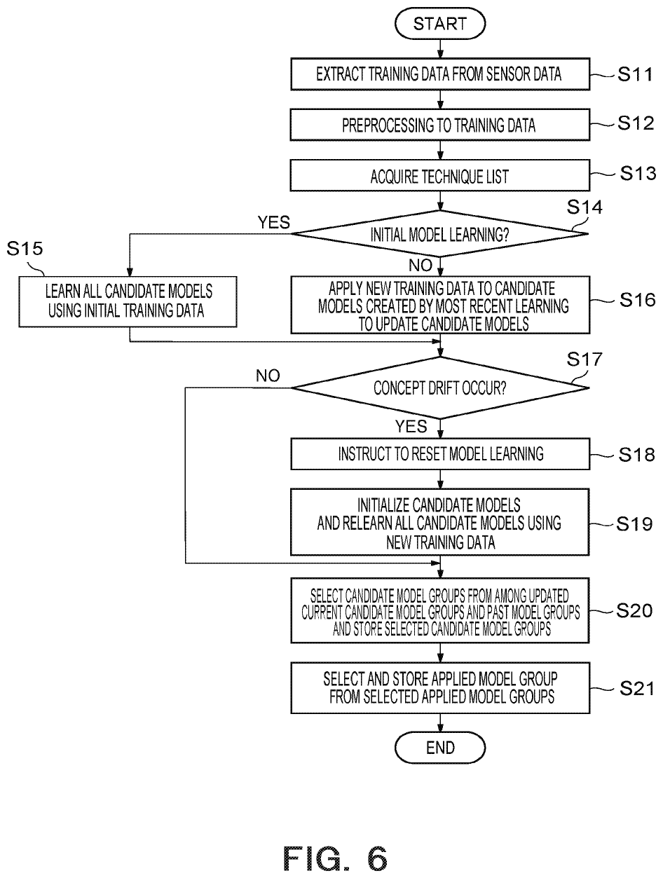

FIG. 6 is a flowchart showing an operation of the anomaly detection apparatus 1 according to the second embodiment. Since steps S11 to S19 of FIG. 6 are equivalent to steps S1 to S9 of FIG. 3, the explanation is omitted. If it is determined in step S17 that a concept drift does not occur or, when, in step S19, the model-group learner/updater 3 initializes the candidate models and relearns all models using new training data, subsequently, the candidate-model group selector 21 selects candidate model groups from among the updated current model groups and past model groups, and stores the selected candidate model groups in the past model-group holder 24 (step S20). Subsequently, the applied-model group selector 22 selects applied model groups of higher decision accuracies from the candidate model groups to create a new applied model (metamodel) using the selected applied model groups and stores the new applied model in the applied model holder 11 (step S21).

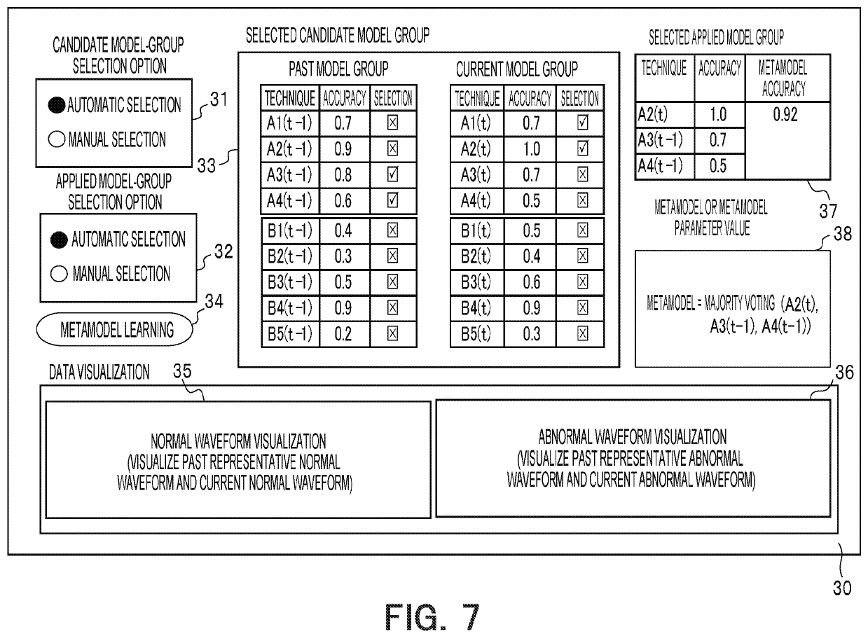

Selection of candidate model groups may be performed by automatic processing or manually. Moreover, whether a concept drift has occurred may be visualized. FIG. 7 is a figure showing an example of a GUI window 30 via which a user performs various selections and visualization. The GUI window 30 of FIG. 7 has a first instructor 31, a second instructor 32, a third instructor 33, a fourth instructor 34, a first visualizer 35, a second visualizer 36, a selected applied-model group indicator 37, and a metamodel information indicator 38. A user performs selection and instruction via the first to fourth instructors 31 to 34.

The first instructor 31 instructs whether to select candidate model groups automatically by the candidate-model group selector 21 or manually by an operator. The second instructor 32 instructs whether to select applied model groups automatically by the applied-model group selector 22 or manually by the operator. The third instructor 33 instructs the selection of candidate models included in the current candidate model groups and the selection of candidate models included in the past candidate model groups when the first instructor 31 instructed to select the candidate model groups manually by the operator. The third instructor 33 is provided with check buttons to instruct whether to select candidate models. The fourth instructor 34 instructs applied model learning after the instructions by the first to third instructors 31 to 33 are finished.

The first visualizer 35 visualizes the waveform of normal sensor data. In more specifically, the first visualizer 35 visualizes a normal waveform of past representative sensor data and the current normal waveform. The second visualizer 36 visualizes the waveform of abnormal sensor data. In more specifically, the second visualizer 36 visualizes an abnormal waveform of past representative sensor data and the current abnormal waveform. The selected applied-model group indicator 37 indicates techniques to be used for creating candidate models that compose an applied model group, decision accuracies, and a decision accuracy of a metamodel based on the applied model group. The metamodel information indicator 38 indicates detailed information of the metamodel or parameter values that identify the metamodel.

A user can visually check whether a concept drift has occurred by checking the waveforms of normal data and abnormal data visualized by the first visualizer 35 and the second visualizer 36, respectively. Moreover, the user can update a normal waveform and an abnormal waveform by selecting a candidate model group having representative normal and abnormal waveforms in the past normal and abnormal data, and updating the selected candidate model group using newly supplied sensor data.

As described above, in the second embodiment, candidate model groups are selected from a plurality of candidate models obtained by unsupervised learning and a plurality of candidate models obtained by supervised learning, at each time, and then applied model groups of high decision accuracies are selected from the candidate model groups to create an applied model (metamodel) from the applied model groups. Accordingly, a final applied model can be created in view of a plurality of candidate models of high decision accuracies, so that anomaly detection of sensor data can be performed more accurately.

Moreover, in the section of applied model groups, not only the current candidate models, but also past candidate models can be included in the selection targets, so that the decision accuracies of the applied model groups can be improved.

Furthermore, in the section of candidate model groups and applied model groups, a user can perform various detailed selections on a GUI window, so that applied model groups and a metamodel can be selected in view of user's intentions.

### Third Embodiment

A third embodiment is to divide sensor data into groups to perform modeling with an optimum technique per group.

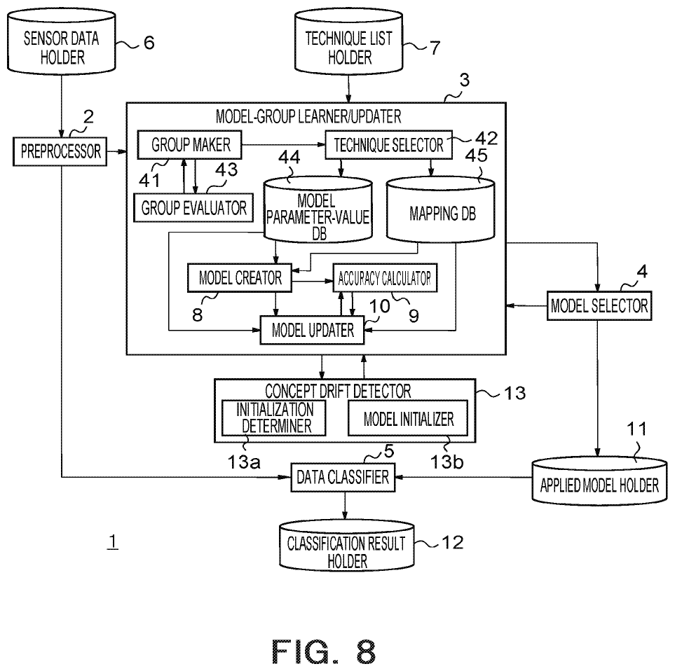

FIG. 8 is a block diagram schematically showing the configuration of an anomaly detection apparatus 1 according to the third embodiment. The anomaly detection apparatus 1 of FIG. 8 is different from the anomaly detection apparatus 1 of FIG. 1 in the internal configuration of the model-group learner/updater 3.

The model-group learner/updater 3 in the anomaly detection apparatus 1 of FIG. 8 has a group maker 41, a technique selector 42, and a group evaluator 43, in addition to the model creator 8, the accuracy calculator 9, and the model updater 10.

The group maker 41 classifies a plurality of sensor data preprocessed by the preprocessor 2 into one or more distinctive groups. In more specifically, the group maker 41 classifies preprocessed training data into a plurality of distinctive data groups. As the grouping technique, a clustering technique, such as k-means clustering, hierarchical clustering etc. can be applied.

The technique selector 42 selects the optimum technique for creating candidate models per data group classified by the group maker 41. The technique selector 42 may select the technique using a combinatorial optimization technique, a heuristic technique or a greedy strategy. When there are m data groups and n techniques, by performing learning of candidate models of m×n combinations, finally an optimum technique can be selected. In addition to the technique selector 42, a model parameter-value DB 44 and a mapping DB 45 may be provided. The model parameter-value DB 44 holds model parameter values corresponding to the technique selected by the technique selector 42. The model parameter values are used for creating candidate models. The mapping DB 45 holds a correspondence relationship between the technique selected by the technique selector 42 and the data group.

The group evaluator 43 calculates an evaluation value of a candidate model created by the technique that is selected by the technique selector 42, for each data group classified by the group maker 41. As required, the group evaluator 43 may select a data group required to be subgrouped. A user may evaluate a data group via GUI.

The model creator 8 creates a candidate model with the technique selected by the technique selector 42, for each data group classified by the group maker 41. The technique selector 42 selects a technique based on the evaluation value calculated by the group evaluator 43, for each data group classified by the group maker 41. The model updater 10 updates the candidate model using a technique selected by another selection performed by the technique selector 42 based on the evaluation value calculated by the group evaluator 43. The model selector 4 creates an anomaly detection model based on the candidate model updated by the model updater 10, for each data group classified by the group maker 41.

The technique selector 42 may utilize a genetic algorithm to select an optimum technique, so that the fitness becomes maximum in the case of creating a candidate model by applying each of a plurality of techniques to each data group classified by the group maker 41.

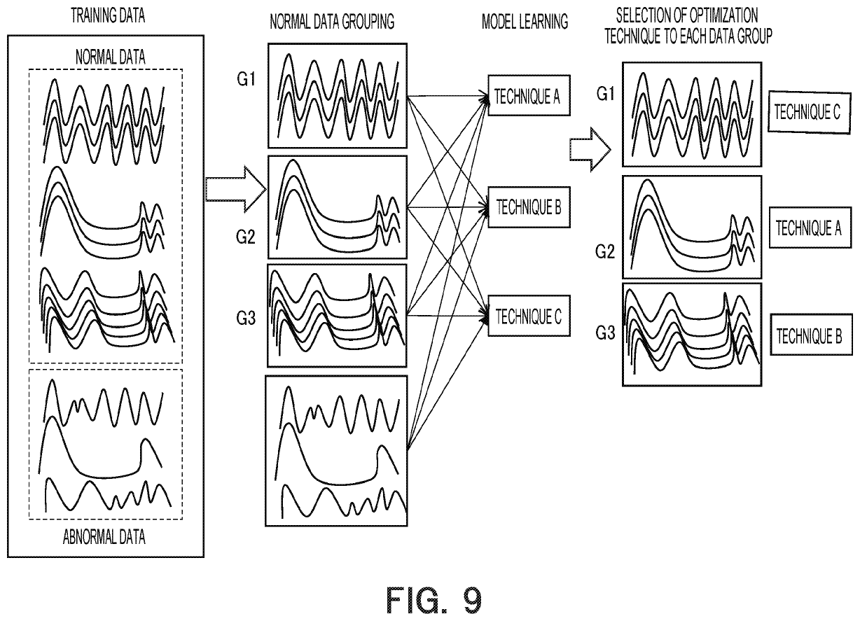

FIG. 9 shows an example in which the normal data is classified into the three data groups G1, G2, and G3, depending on the waveform shapes. Any technique can be assigned to each of data groups G1 to G3. FIG. 9 shows an example in which the decision accuracies of candidate models created by assigning techniques A, B, and C to each of the data groups G1 to G3 are evaluated by the group evaluator 43, and finally, the techniques A, B, and C are assigned to the data groups G2, G3, and G1, respectively.

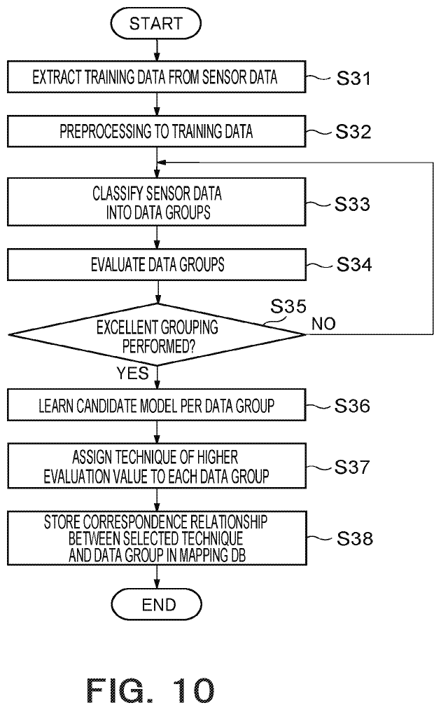

FIG. 10 is a flowchart showing operations of the group maker 41 and the technique selector 42 according to the third embodiment. First of all, the preprocessor 2 extracts training data from sensor data (step S31), and performs preprocessing of, for example, adjusting the data length (step S32). Subsequently, the group maker 41 classifies, by clustering, the sensor data into a plurality of distinctive data groups (step S33). Subsequently, the group evaluator 43 evaluates the data groups (step S34). Specifically, the group evaluator 43 evaluates whether excellent grouping has been performed (step S35). If it is evaluated that excellent grouping has not been performed, the group evaluator 43 instructs another grouping to the group maker 41, by indicating data groups which require subgrouping, deletion, etc., for example. In this case, step S33 and the following steps are repeated.

On the other hand, if the group evaluator 43 evaluates that excellent grouping has been performed, the technique selector 42 applies various techniques to each grouped data group to learn candidate models (step S36). The group evaluator 43 calculates evaluation values of the candidate models created by applying various techniques to each data group to assign a technique of a higher evaluation value to each data group (step S37). The technique selector 42 stores model parameter values to be used in creating candidate models in the model parameter-value DB 44 and stores the correspondence relationship between the techniques selected by the technique selector 42 and the data groups in the mapping DB 45 (step S38).

After step S38 completes, step S4 and the following steps of FIG. 3 are performed per data group.

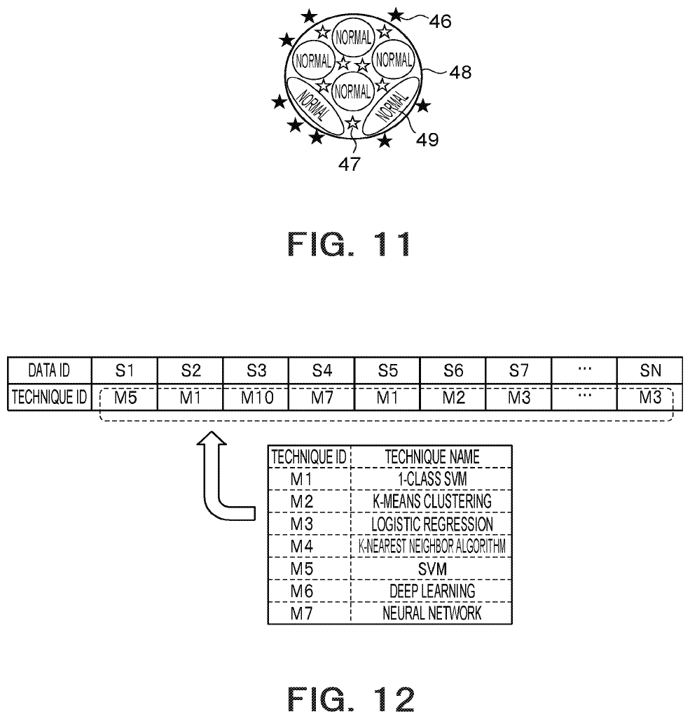

FIG. 11 is a figure schematically illustrating the significance of grouping to be performed by the anomaly detection apparatus 1 according to the third embodiment. In FIG. 11, black star marks 46 indicate an anomaly detectable by conventional techniques, whereas open star marks 47 indicate an anomaly undetectable by the conventional techniques. In the conventional techniques, the area without the black star marks 46 is determined to be normal, so that an anomaly detection model, with which the area inside a large circle 48 in FIG. 11 is determined to be normal, is created. In contrast, according to the anomaly detection apparatus 1 of FIG. 11, the large circle 48 is divided into a plurality of data groups to create an anomaly detection model per data group, so that a plurality of anomaly detection models composed of a plurality of small circles 49 are created. Therefore, the open star marks 47 conventionally undetectable can be correctly detected as abnormal.

FIG. 12 is a figure showing an example of grouping normal data (training data) using a genetic algorithm. In FIG. 12, sensor data are classified into N (N being an integer of 2 or larger) data groups and a technique is assigned to each data group by the genetic algorithm, to create candidate models. The technique to be assigned to each data group is, for example, 1-class SVM, k-means clustering, logistic regression, k-nearest neighbor algorithm, SVM, deep learning, neural network, and so on.

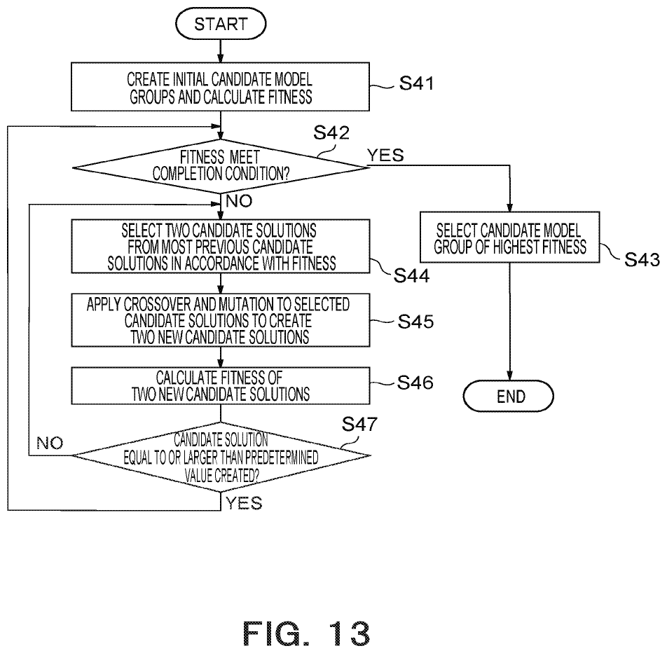

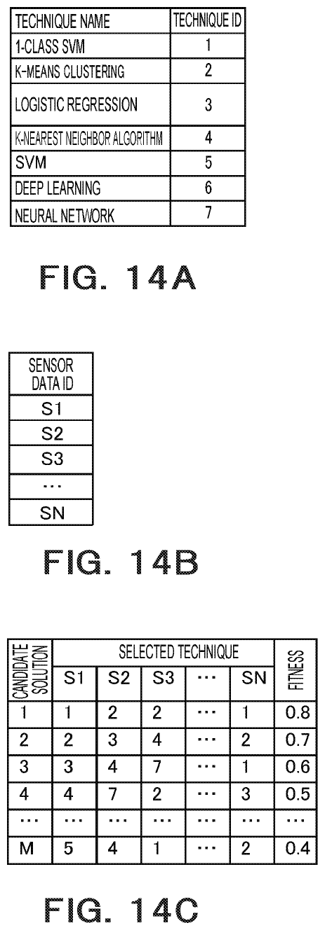

FIG. 13 is a figure explaining the process of genetic algorithm to be used in assigning a technique to each data group in FIG. 12. In FIG. 13, based on a technique list (FIG. 14A) including IDs that identify the above-described seven techniques and a sensor data list (FIG. 14B) including IDs that identify N data groups, initial candidate model groups composed of M (M being an integer of 2 or larger) candidate solutions are created (FIG. 14C), and then the fitness for evaluating each candidate model group is calculated (step S41). As shown in FIG. 14C, the M candidate solutions are different from one other in the combination of techniques to be used by the respective candidate models.

Subsequently, it is determined whether the fitness meets a completion condition (step S42). Meeting the completion condition is the case where the fitness becomes equal to or larger than a predetermined value (for example, 1.0). Meeting the completion condition may be the case where the number of process repetition reaches a predetermined number. When the fitness meets the completion condition, for example, a candidate model group of the highest fitness is selected (step S43).

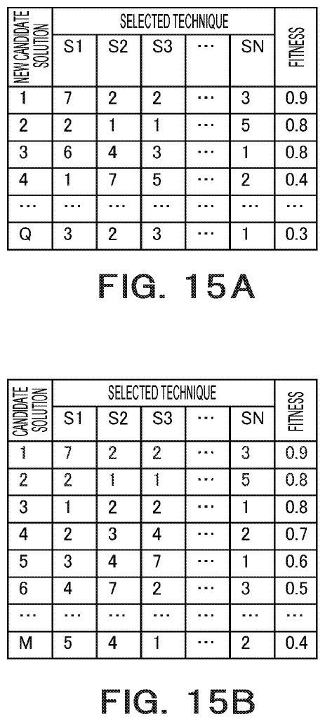

If it is determined in step S42 that the fitness does not meet the completion condition, the genetic algorithm is utilized to perform the following steps S44 to S46. In step S44, two candidate solutions are selected from the most previous candidate solutions in accordance with the fitness. FIG. 15A is a figure showing a list of the most previous candidate solutions for a plurality of candidate model groups. In step S44, from this list, two upper candidate solutions with higher fitness are selected. Subsequently, in step S45, crossover and mutation are applied to the selected candidate solutions to create two new candidate solutions. Through step S45, a list such as shown in FIG. 15B is obtained. In step S46, the fitness of the two new candidate solutions is calculated.

Subsequently, it is checked in step S47 whether a new candidate solution equal to or larger than a predetermined value has been created. If the number of new candidate solutions equal to or larger than the predetermined value has not been created (NO in step S47), two new candidate solutions are created through steps S44 to S46. If the number of new candidate solutions equal to or larger than the predetermined value has been created (YES in step S47), step S42 is performed.

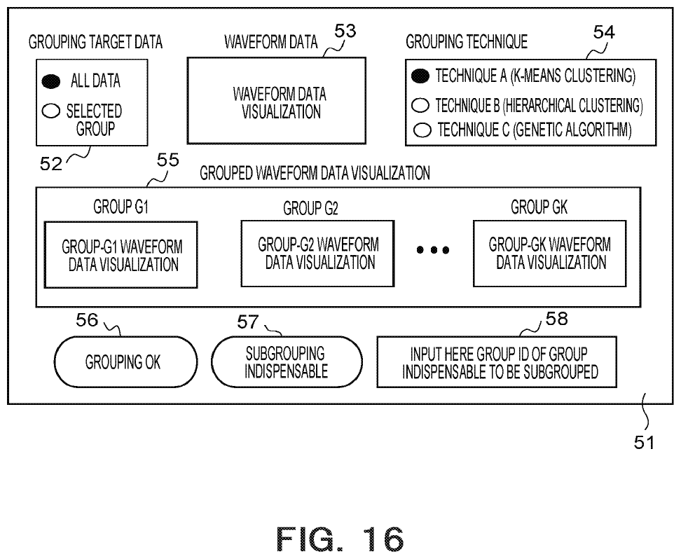

The group evaluator 43 of FIG. 8 may evaluate the data groups based on user settings. FIG. 16 is a figure showing an example of a GUI window 51 for data group evaluation. The GUI window 51 of FIG. 16 has a first selector 52, a first visualizer 53, a second selector 54, a second visualizer 55, a third selector 56, a fourth selector 57, and a group ID inputter 58.

The first selector 52 selects whether to group all sensor data or part of the sensor data. The first visualizer 53 visualizes sensor data to be supplied to the data group selected by the first selector 52. The second visualizer 55 visualizes a candidate model created by the technique that is selected by the second selector 54, for each data group classified by the group maker 41. The third selector 56 selects whether to finish grouping. The fourth selector 57 selects whether to perform subgrouping. The group ID inputter 58 inputs an identification number of a data group to be subgrouped, when subgrouping is performed.

FIG. 16 shows an example of selecting one technique from among a technique A (k-means clustering), a technique B (hierarchical clustering), and a technique C (genetic algorithm). Selectable specific techniques are not limited to those shown in FIG. 16.

The second visualizer 55 displays a result of grouping. Specifically, the second visualizer 55 visualizes waveform data per data group. When a data group is subgrouped, subgroup waveform data is visualized.

The third selector 56 is operated by a user when the user determines that the waveform data visualized by the second visualizer 55 is excellent as a result of grouping. By the operation of this button, grouping is complete.

As described above, in the third embodiment, sensor data is classified into a plurality of data groups and the optimum technique is selected per data group to create an anomaly detection model for each data group. Accordingly, an anomaly conventionally undetectable can be correctly detected, so that the anomaly detection accuracy can be improved.

At least part of the anomaly detection apparatus 1 explained in the above-described embodiments may be configured with hardware or software. When it is configured with software, a program that performs at least part of the anomaly detection apparatus 1 may be stored in a storage medium such as a flexible disk and CD-ROM, and then installed in a computer to run thereon. The storage medium may not be limited to a detachable one such as a magnetic disk and an optical disk but may be a standalone type such as a hard disk and a memory.

Moreover, a program that achieves the function of at least part of the anomaly detection apparatus 1 may be distributed via a communication network (including a wireless communication) such as the Internet. The program may also be distributed via an online network such as the Internet or a wireless network, or stored in a storage medium and distributed under the condition that the program is encrypted, modulated or compressed.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An anomaly detection apparatus comprising:
a model creator, based on a plurality of sensor data input sequentially in time, to create a plurality of candidate models with a plurality of techniques for detection of an anomaly of the sensor data;
an accuracy calculator to calculate decision accuracies of the plurality of candidate models;
a model selector to select at least one anomaly detection model from among the plurality of candidate models based on the decision accuracies of the plurality of candidate models;
a data classifier to determine whether new sensor data is normal or abnormal based on the selected anomaly detection model; and
a model updater to update the plurality of candidate models based on the decision accuracies of the plurality of candidate models calculated by the accuracy calculator and on the new sensor data determined to be normal or abnormal by the data classifier.

2. The anomaly detection apparatus of claim 1, wherein the model selector comprises:
a candidate-model group selector to select either a first candidate model group including the plurality of candidate models created based on sensor data determined to be normal by the data classifier or a second candidate model group including the plurality of candidate models created based on sensor data determined to be normal or abnormal by the data classifier;
an applied-model group selector to select an applied model group including one or more candidate models from the first candidate model group or the second candidate model group selected by the candidate-model group selector; and
an applied model creator to decide an applied model created based on the applied model group, as the anomaly detection model.

3. The anomaly detection apparatus of claim 2, wherein the candidate-model group selector selects either the first candidate model group or the second candidate model group based on decision accuracies of the plurality of candidate models in the first candidate model group and decision accuracies of the plurality of candidate models in the second candidate model group, and
the applied-model group selector selects the applied model group based on the decision accuracies of the plurality of candidate models in the first candidate model group or the second candidate model group selected by the candidate-model group selector.

4. The anomaly detection apparatus of claim 2 further comprising:
a first instructor to instruct whether to select the candidate model group automatically by the candidate-model group selector or manually by an operator;
a second instructor to instruct whether to select the applied model group automatically by the candidate-model group selector or manually by the operator;
a third instructor to instruct selection of a candidate model included in a current candidate model group and selection of a candidate model included in a past candidate model group, when it is instructed that the operator select the applied model group manually;
a fourth instructor to instruct learning of the applied model after completion of instructions by the first, second and third instructors;
a first visualizer to visualize a waveform of normal sensor data; and
a second visualizer to visualize a waveform of abnormal sensor data.

5. The anomaly detection apparatus of claim 1 further comprising:
an initialization determiner to determiner whether all of numerical values indicating decision accuracies of the plurality of candidate models become equal to or smaller than a predetermined value; and
a candidate models initializer to initialize the anomaly detection model when all of the numerical values indicating the decision accuracies of the plurality of candidate models are determined to be equal to or smaller than the predetermined value.

6. The anomaly detection apparatus of claim 1 further comprising:
a group maker to classify the plurality of sensor data into one or more distinctive data groups;
a technique selector to select a technique optimum for creating a candidate model, for each of the data groups classified by the group maker; and
a group evaluator to calculate an evaluation value of the candidate model created by the technique selected by the technique selector, for each of the data groups classified by the group maker,
wherein the model creator creates the candidate model with the technique selected by the technique selector, for each of the data groups classified by the group maker,
the technique selector selects the technique based on the evaluation value calculated by the group evaluator, for each of the data groups classified by the group maker,
the model updater updates the candidate model using a technique selected by another selection by the technique selector based on the evaluation value calculated by the group evaluator, and
the model selector creates the anomaly detection model based on the candidate model updated by the model updater, for each of the data groups classified by the group maker.

7. The anomaly detection apparatus of claim 6, wherein the technique selector selects the optimum technique utilizing a genetic algorithm so that fitness becomes maximum when the candidate model is created by applying the plurality of techniques to each of the data groups classified by the group maker.

8. The anomaly detection apparatus of claim 6, wherein the group evaluator comprises:
a first selector to select whether to perform grouping to all sensor data or part of the sensor data;
a first visualizer to visualize sensor data to be supplied to a data group selected by the first selector;
a second selector to select a technique for creating a candidate model, for each of data groups to be classified by the group maker;
a second visualizer to visualize the candidate model created by the technique selected by the second selector, for each of data groups to be classified by the group maker;
a third selector to select whether to finish grouping;
a fourth selector to select whether to perform subgrouping; and
a group ID inputter to input an identification number of a data group to be subgrouped when performing subgrouping.

9. The anomaly detection apparatus of claim 1 further comprising a preprocessor to perform preprocessing to the plurality of sensor data input sequentially in time;
wherein the model creator creates the plurality of candidate models based on the plurality of preprocessed sensor data, and
the data classifier determines whether the plurality of sensor data preprocessed by the preprocessor are normal or abnormal.

10. The anomaly detection apparatus of claim 1, wherein the model updater updates the plurality of candidate models based on at least either of the new sensor data determined to be normal or abnormal by knowledge of an expert and the new sensor data determined to be normal or abnormal based on the anomaly detection model in addition to the knowledge of the expert.

11. An anomaly detection method causing a computer to execute a process comprising:
creating, based on a plurality of sensor data input sequentially in time, a plurality of candidate models with a plurality of techniques, for detection of an anomaly of the sensor data;
calculating decision accuracies of the plurality of candidate models;
selecting at least one anomaly detection model from among the plurality of candidate models based on the decision accuracies of the plurality of candidate models;
determining whether new sensor data is normal or abnormal based on the selected anomaly detection model; and
updating the plurality of candidate models based on the calculated decision accuracies of the plurality of candidate models and on the new sensor data determined to be normal or abnormal.

12. The anomaly detection method of claim 11, wherein creating the anomaly detection model comprises:
selecting either a first candidate model group including the plurality of candidate models created based on sensor data determined to be normal or a second candidate model group including the plurality of candidate models created based on sensor data determined to be normal or abnormal;
selecting an applied model group including one or more candidate models from the selected first or second candidate model group; and
deciding an applied model created based on the applied model group, as the anomaly detection model.

13. The anomaly detection method of claim 12, wherein selecting the candidate model group comprises selecting either the first candidate model group or the second candidate model group based on decision accuracies of the plurality of candidate models in the first candidate model group and decision accuracies of the plurality of candidate models in the second candidate model group, and
selecting the applied model group comprises selecting the applied model group based on the decision accuracies of the plurality of candidate models in the selected first or second candidate model group.

14. The anomaly detection method of claim 12 further comprising:
instructing, by a first instruction, whether to select the candidate model group automatically or manually by an operator;
instructing, by a second instruction, whether to select the applied model group automatically or manually by the operator;
instructing, by a third instruction, selection of a candidate model included in a current candidate model group and selection of a candidate model included in a past candidate model group, when it is instructed that the operator select the applied model group manually;
instructing learning of the applied model after completion of the first, second and third instructions;
visualizing a waveform of normal sensor data; and
visualizing a waveform of abnormal sensor data.

15. The anomaly detection method of claim 11 further comprising:
determining whether all of numerical values indicating decision accuracies of the plurality of candidate models become equal to or smaller than a predetermined value; and
initializing the anomaly detection model when all of the numerical values indicating the decision accuracies of the plurality of candidate models are determined to be equal to or smaller than the predetermined value.

16. The anomaly detection method of claim 11 further comprising:
classifying the plurality of sensor data into one or more distinctive data groups;
selecting a technique optimum for creating a candidate model, for each of the classified data groups; and
calculating an evaluation value of the candidate model created by the selected technique, for each of the classified data groups,
wherein creating the plurality of candidate models comprises creating the candidate model with the selected technique, for each of the classified data groups,
selecting the optimum technique comprises selecting the technique based on the evaluation value, for each of the classified data groups,
updating the plurality of candidate models comprises updating the candidate models using an optimum technique selected by another selection based on the calculated evaluation value, and
creating the anomaly detection model comprises creating the anomaly detection model based on the updated candidate model, for each of the classified data groups.

17. The anomaly detection method of claim 16, wherein selecting the optimum technique comprises utilizing a genetic algorithm so that fitness becomes maximum when the candidate model is created by applying the plurality of techniques to each of the classified data groups.

18. The anomaly detection method of claim 16, wherein calculating the evaluation value of the candidate model created by the selected technique comprises:
selecting whether to perform grouping to all sensor data or part of the sensor data;
visualizing sensor data to be supplied to a selected data group;
selecting a technique for creating a candidate model, for each of data groups to be classified;
visualizing the candidate model created by the selected technique, for each of data groups to be classified;
selecting whether to finish grouping;
selecting whether to perform subgrouping; and
inputting an identification number of a data group to be subgrouped when performing subgrouping.

19. The anomaly detection method of claim 11 further comprising performing preprocessing to the plurality of sensor data input sequentially in time,
wherein creating the plurality of candidate models comprises creating the plurality of candidate models based on the plurality of preprocessed sensor data, and
determining whether the new sensor data is normal or abnormal comprises determining whether the plurality of preprocessed sensor data are normal or abnormal.

20. The anomaly detection method of claim 11, wherein updating the plurality of candidate models comprises updating the plurality of candidate models based on at least either of the new sensor data determined to be normal or abnormal by knowledge of an expert and the new sensor data determined as normal or abnormal based on the anomaly detection model in addition to the knowledge of the expert.
